(19) United States
(12) Patent Application Publication
(10) Pub. No.: US 2017/0229219 A1
(43) Pub. Date: Aug. 10, 2017

(54) Semiconductor Ceramic Composition And PTC Thermistor

(71) Applicant: TDK CORPORATION, Tokyo (JP)

(72) Inventors: Kazuhiko ITOH, Tokyo (JP); Yoshikazu SHIMURA, Tokyo (JP); Kazutaka FUJITA, Tokyo (JP); Hiroki MORIKOSHI, Tokyo (JP); Tomohiro TERADA, Tokyo (JP)

(73) Assignee: TDK CORPORATION, Tokyo (JP)

(21) Appl. No.: 15/409,989

(22) Filed: Jan. 19, 2017

(30) Foreign Application Priority Data
Feb. 8, 2016 (JP) 2016-021460

(51) Int. Cl. H01C 7/02; H01C 1/14; C04B 35/645; C04B 35/468; C04B 35/626

(52) U.S. Cl. CPC H01C 7/022; C04B 35/4682; C04B 35/6264; C04B 35/6261; C04B 35/62675; C04B 35/645; H01C 1/14; C04B 2235/3201; C04B 2235/3215; C04B 2235/3208; C04B 2235/3236; C04B 2235/3298; C04B 2235/3436; C04B 2235/3268; C04B 2235/3225; C04B 2235/3255; C04B 2235/3224; C04B 2235/602; C04B 2235/612; C04B 2235/656

(57) ABSTRACT

A semiconductor ceramic composition which is a BaTiO₃ based semiconductor ceramic composition, wherein, part of Ba is replaced by at least A (at least one alkali metal element selected from Na and K), Bi and RE (at least one element selected from rare earth elements including Y), and part of Ti is replaced by at least TM (at least one element selected from the group including of V, Nb and Ta), the relationships of 0.7≦{(the content of Bi)/(the content of A)}≦1.43, 0.017≦{(the content of Bi)+(the content of A)}≦0.25, and 0<{(the content of RE)+(the content of TM)}≦0.01 are satisfied when the total content of Ti and TM is set as 1 mol, the grain sizes have a maximum peak in a grain size distribution in a range of 1.1 μm to 4.0 μm or less, and the distribution frequency of the peak is 20% or more.

The present invention relates to a semiconductor ceramic composition and a PTC thermistor which are used in a heater element or an element for detecting overheats.

### BACKGROUND

A PTC (Positive Temperature Coefficient) thermistor having positive temperature coefficient of resistance is known as one of the thermistors. The resistance in the PTC thermistor increases as the temperature rises, so the PTC thermistor is used as a self-controlling heater element, an over-current protection element, an element for detecting overheats or the like. In the past, the PTC thermistor was formed by adding a trace of rare earth based elements or the like into the main component of barium titanate (BaTiO₃) to turn it into a semiconductor. The resistance of the thermistor is low under a temperature below the Curie point; however, it will be sharply increased by several orders of magnitude under a temperature above the Curie point.

Usually, the Curie point of BaTiO₃ is about 120° C. When part of Ba is replaced by Sr or part of Ti is replaced by Sn, the Curie point can be shifted to a lower temperature. However, for shifting the Curie temperature towards a higher temperature, the current method is replacing part of Ba by Pb. Thus, an alternative material without using Pb is required to be applied from the viewpoint of the worldwide trend of reducing the environmental burden.

A semiconductor ceramic composition with a small resistivity at 25° C. and a Curie point shifted to 130 to 183° C. without using Pb is disclosed in the following Patent Document 1. The semiconductor ceramic composition can be obtained by replacing part of Ba in BaTiO₃ with Bi, alkali metal A1 (one or more selected from Na, K and Li) and rare earth element Q (one or more selected from La, Dy, Eu, and Gd) and adjusting the content of (Bi_{0.5}Al_{0.5}) and Q to specified ranges.

### PATENT DOCUMENT

Patent Document 1: JP-B-4765258

### SUMMARY

In the Patent Document 1, it has been described that a semiconductor ceramic composition with a small resistivity at 25° C. can be obtained and its Curie point can be shifted to 130 to 183° C. without using Pb. However, when the composition is considered to be used as a PTC thermistor, especially as a heater element, its withstand voltage or mechanical strength is likely to be not sufficient.

For example, the PTC thermistor used for interior heating in the vehicle functions as a heater element and is applied with a high voltage under the condition of being clamped by fin made of aluminum, so it is required to have an excellent mechanical strength and a high withstand voltage.

In view of the situations mentioned above, the present invention aims to provide a semiconductor ceramic composition whose Curie point is shifted to a temperature higher than 120° C. and a PCT thermistor comprising the same, wherein the semiconductor ceramic composition has a small resistivity at 25° C. and an excellent withstand voltage and mechanical strength.

The semiconductor ceramic composition is characterized in that part of Ba in the BaTiO₃ based semiconductor ceramic composition is replaced by at least A (at least one alkali metal element selected from the group consisting of Na and K), Bi and RE (at least one element selected from the group consisting of rare earth elements including Y), part of Ti is replaced by at least TM (at least one element selected from the group consisting of V, Nb and Ta); the inequations, i.e., 0.7≦{(the content of Bi)/(the content of A)}≦1.43, 0.017≦{(the content of Bi)+(the content of A)}≦0.25, and 0≦{(the content of RE)+(the content of TM)}≦0.01, are satisfied when {(the content of Ti)+(the content of TM)} is set as 1 mol; the semiconductor ceramic composition is composed of several crystal grains; the grain sizes of the several crystal grains have a maximum peak in the grain size distribution in the range of 1.1 μm or more and 4.0 μm or less, and the distribution frequency of the peak is 20% or more.

In addition, the PCT thermistor according to the present invention is characterized in that a pair of electrodes is formed on the surface of a ceramic body formed by using the above semiconductor ceramic composition.

According to the present invention, a semiconductor ceramic composition whose Curie point is shifted to a temperature higher than 120° C. and a PCT thermistor comprising the same can be provided, wherein the semiconductor ceramic composition has a small resistivity at 25° C. and an excellent withstand voltage and mechanical strength.

### BRIEF DESCRIPTION OF THE DRAWINGS

FIG. 1 is a perspective view showing a structure of the PTC thermistor comprising the semiconductor ceramic composition according to one embodiment of the present invention.

FIG. 2 is a view showing the grain size distribution of the semiconductor ceramic composition according to one embodiment of the present invention.

### DETAILED DESCRIPTION OF EMBODIMENTS

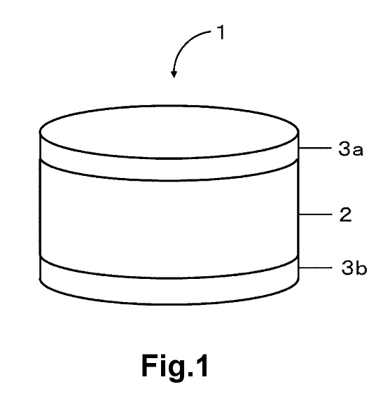

As shown in FIG. 1, PTC thermistor 1 comprises ceramic body 2 which is composed of BaTiO₃ based semiconductor ceramic composition of the present invention, and a pair of electrodes 3a and 3b which is formed on the opposite surfaces of the ceramic body. The electrodes 3a and 3b can be formed with a single-layered structure or a multi-layered structure which is made of conducting materials such as Cu, Ni, Al, Cr, Zn, Ag, Ni—Cr alloy, Ni—Cu alloy, or the like.

The semiconductor ceramic composition according to one embodiment of the present invention can be any composition as long as it comprises the following composition, i.e., part of Ba of BaTiO₃ is replaced by Bi and A (at least one alkali metal element selected from the group consisting of Na and K), besides part of Ba is replaced by RE (at least one element selected from the group consisting of rare earth elements including Y) and part of Ti is replaced by TM (at least one element selected from the group consisting of V, Nb and Ta), wherein RE and TM are functioned as agents for semiconducting. For example, the composition is represented by the following formula (1).

(Ba_{1-b-c-e}Bi_{b}A_{c}REₑ)(Ti_{1-f}TM_{f})O₃ (1)

In formula (1), b, c, e, and f preferably satisfy the following inequations (2) to (4), wherein b, c, e, and f respectively represent the amounts of Bi, A and RE to replace part of Ba site, and the amount of TM to replace part of Ti site.

0.7≦b/c≦1.43 (2)

0.017≦(b+c)≦0.25 (3)

0≦(e+f)≦0.01 (4)

In addition, the semiconductor ceramic composition is composed of several crystal grains. The grain sizes of the several crystal grains have a maximum peak in the grain size distribution in the range of 1.1 μm or more and 4.0 μm or less, and the distribution frequency of the peak is 20% or more.

The resistivity at 25° C. is low, the withstand and the mechanical strength are high, and further the Curie point can be shifted to a temperature higher than 120° C. by satisfying the above inequations (2) to (4), setting the range of the maximum peak of the grain size distribution to be 1.1 μm or more and 4.0 μm or less, and adjusting the distribution frequency of the peak to 20% or more. In addition, the Curie point of the present invention refers to the temperature, at which the resistivity of the semiconductor ceramic composition is twice as high as that at 25° C. The mentioned range of the maximum peak of the grain size distribution as well as the distribution frequency of the peak can be obtained by satisfying the above inequations (2) to (4) in formula (1) and properly adjusting the grain size of the raw material TiO₂ and the pulverization time in a ball mill after calcining process.

In addition, the grain size distribution of the crystal grains is achieved by image analysis from a scanning electron microscope image obtained by etching the polished cross-section with the semiconductor ceramic composition (sintered body) embedded. In particular, an image processing software, i.e., Mac-view, is used, the size of grains and the number is calculated by a scanning electron microscope, the grain size is regarded as Heywood diameter, and then the grain size distribution is calculated from the volume distribution. Further, the magnification in the scanning electron microscope image is set to have 50 or more grains.

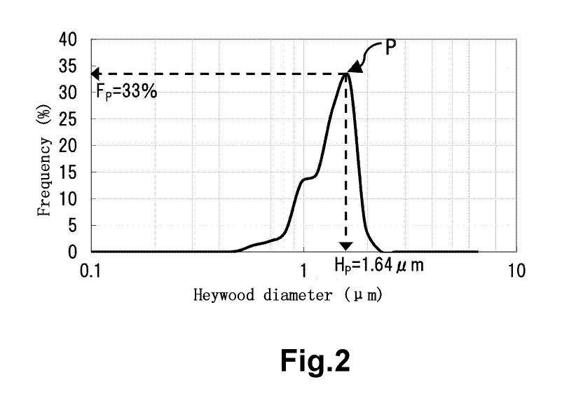

FIG. 2 shows an example of the grain size distribution of the crystal grains obtained by the above mentioned method. Here, the maximum peak is the peak P when the frequency of the volume distribution relative to the Heywood diameter is obtained. At that time, when the Heywood diameter H_{P} falls within the range of 1.1 Lm or more and 4.0 μm or less and the frequency F_{P} is 20% or more, a semiconductor ceramic composition with a low resistivity at 25° C. and an excellent withstand voltage and mechanical strength. In the example shown in FIG. 2, H_{P} is 1.64 μm and F_{P} is 33%, which are within the above ranges.

Moreover, the range of the crystal grain size of the horizontal axis (i.e., Heywood diameter) is a default setting and is divided into 42 parts in the range of 0.005 to 6.541 μm.

In formula (1), the content b of Bi and the content c of A preferably satisfy 0.017≦(b+c)≦0.25 and 0.7≦b/c≦1.43 in terms of molar ratio when (Ti+TM) is set as 1 mol. If (b+c) is less than 0.017, the Curie point will not be shifted to a temperature higher than 120° C., and thus it is not preferable. In addition, it is not preferred to render (b+c) higher than 0.25 because the ceramic composition will not completely become semiconductive and the resistivity at 25° C. will increase. Further, in the case where 0.7≦b/c≦1.43 is not satisfied, the ceramic composition will not completely become semiconductive and the resistivity at 25° C. will increase, and thus it is not preferred.

In formula (1), RE (at least one element selected from rare earth elements including Y) and TM (at least one element selected from the group consisting of V, Nb and Ta) function as agents for semiconducting, and the total amount (e+f) of RE and TM preferably falls within the range, i.e., 0≦(e+f)≦0.01. When (e+f) is 0 or higher than 0.01, the resistivity at 25° C. will increase, and thus it is not preferred. More preferably, an effect of decreasing the resistivity at 25° C. is large when the range is set to be 0.001 or more and 0.006 or less. Besides, RE or TM can be used alone as the agent for semiconducting, and the preferred additive amounts of RE and TM are the same. More preferably, RE is selected from the group consisting of La, Sm and Gd, and Nb is selected as TM. More preferably, RE (Sm, Gd, Er) and TM (Nb) are added in equal amounts. With such types of agents for semiconducting and adding methods, the effect on decreasing the resistivity at 25° C. will be slightly improved.

In addition, the molar ratio of (the total molar number of Ba, Bi, A, and RE) to (the total molar number of Ti and TM) in the semiconductor ceramic composition more preferably satisfies 1.001 or more and 1.06 or less. Thus, the resistivity at 25° C. can be further reduced.

In addition, it is preferable in the semiconductor ceramic composition that Ca is contained in a ratio of 0.049 mol or less in terms of element when the total content of Ti and TM is set as 1 mol. Thus, the sintered density will be enhanced and the resistivity at 25° C. can be further reduced.

In addition, it is preferable in the semiconductor ceramic composition that Mn is contained in an amount of 0.003 mol or less in terms of element when the total content of Ti and TM is set as 1 mol. Thus, a proper acceptor level will be formed at the grain boundary so that PTC jump will be improved. However, if more than 0.003 mol of Mn is contained, the trap for the conduction electrons will be excess so that the resistivity at 25° C. tends to slightly increase. In addition, the PTC jump is an index for estimating the performance of the PTC thermistor, and it can be calculated from Log₁₀ (resistivity at 280° C./resistivity at 25° C.).

In addition, it is preferable in the semiconductor ceramic composition that Si is contained in an amount of 0.015 mol or less in terms of element when the total content of Ti and TM is set as 1 mol. Thus, the resistivity at 25° C. can be further decreased. However, if more than 0.015 mol of Si is contained, the excess element Si will segregate in a large quantity at the grain boundary so that the movement of conduction electrons will be inhibited and the resistivity at 25° C. tends to be slightly deteriorated.

In addition, in the cases that the alkali metallic element A is Na or K, the shifting amounts of the Curie temperature towards a higher temperature are different, while the resistivities at 25° C. or the withstand voltages and the mechanical strengths are the same.

The semiconductor ceramic composition of the present invention is obtained by mixing compounds which contain elements constituting the formula (1), calcining the mixture, pulverizing the calcined powder, adding binders to granulate and molding the powder, debinding and then sintering. The sintering process can be performed either in air or in a nitrogen atmosphere. However, when the sintering process is performed in a nitrogen atmosphere, an additional thermal treatment at 800 to 1000° C. under an oxidative atmosphere is required. Thus, from the viewpoint of simple processes, the sintering process is preferred to be performed in air.

In addition, the present invention is not limited to the above embodiment. For example, in the semiconductor ceramic composition, the properties will not be influenced even when inevitable impurities are mixed as long as the following conditions are satisfied, i.e., part of Ba is replaced by at least A (at least one alkali metal element selected from the group consisting of Na and K), Bi and RE (at least one element selected from the group consisting of rare earth elements including Y); part of Ti is replaced by at least TM (at least one element selected from the group consisting of V, Nb and Ta); the inequations, i.e., 0.7≦{(the content of Bi)/(the content of A)}≦1.43, 0.017≦{(the content of Bi)+(the content of A)}≦0.25, and 0≦{(the content of RE)+(the content of TM)}≦0.01, are satisfied when {(the content of Ti)+(the content of TM)} is set as 1 mol; a maximum peak of the grain size distribution is provided within the range of the grain size being 1.1 μm or more and 4.0 μm or less; and the distribution frequency of the peak is 20% or more. For example, zirconia ball is used as the grinding media during the wet mixing and pulverizing, and thus zirconia is likely to be mixed into the mixture with an amount of about 0.2 to 0.3 wt %, but it will not affect the properties of the composition. Similarly, Fe, Al, Sr and the like contained in the body materials with a trace amount of about 10 wt ppm are likely to be mixed into the mixture, but they will not affect the properties of the composition especially.

Further, the semiconductor ceramic composition of the present embodiment may contain Pb as the impurity. However, the amount of Pb is preferably lwt % or less, and it is more preferable that no Pb is contained. This is because the volatilization of Pb during the sintering process or the discharge of Pb into the environment after it is distributed in the market as a PTC thermistor and then abandoned can be inhibited to be a minimum, and the above amount of Pb is preferred from the viewpoint of low pollution, environmental friendliness and ecology.

### EXAMPLES

Hereinafter, the present invention will be further described in detail based on Examples and Comparative Examples, but the present invention will not be limited to the following Examples.

### Example 1 (Samples No. 1 to 65) and Comparative Examples 1 to 20

BaCO₃, TiO₂, Bi₂O₃, Na₂CO₃, K₂CO₃, CaCO₃, SiO₂, MnCO₃, the oxide of RE (such as Y₂O₃), and the oxide of TM (such as Nb₂O₅) were prepared as the raw materials and then weighed to have the compositions as shown in Tables 1 to 7 after the sintering process. Next, the resultant mixture was subjected to a wet mixing process with acetone in a ball mill followed by a drying process and a calcining process at 900° C. for 2 hours. Here, the particle size of the raw material TiO₂ will influence the grain particle size of the sintered body, thus, the raw material TiO₂ was used with an average particle size D50 of 0.7 μm in the examples. In addition, the average particle size D50 of the raw material TiO₂ was obtained by using Microtrac MT3000II.

The calcined body was subjected to a wet pulverizing process in pure water by using a ball mill. Here, since the pulverization time with a ball mill would have an effect on the distribution frequency of the maximum peak of the grain size distribution of the sintered body, the pulverization time was set as 17 hours in the example. In addition, the average particle size D50 of the pulverized powder was 0.5 to 0.8 μm. Here, the average particle size D50 of the pulverized powder was obtained by Microtrac MT3000II as the same way as that of the raw material TiO₂. After that, the mixture was dehydrated to dry and then granulated with binders such as polyvinyl alcohol to provide a granulated powder. The granulated powder was molded to have a plate shape (□50 mm×thickness of 2.5 mm) with a uniaxial press machine and then sintered at 1200° C. in air for 2 hours to provide a sintered body.

The two faces of the sintered body were polished to make the thickness be 1.5 mm, and then the sintered body was cut by using a wet dicer into a strip with a size of 35 mm×6.5 mm. The cut sintered body was measured to obtain a three-point bending strength according to JIS R 1601. Further, a paste of Ag—Zn was coated on both faces of the cut sintered body by screen printing, and the sintered body was baked at 500 to 700° C. in air. After that, the temperature properties were measured from 25° C. to 280° C. Further, the withstand voltage was measured. In addition, a maximum peak of the grain size distribution and a distribution frequency of the peak were obtained from the cross-section of the sintered body by the method mentioned above. The results of Example 1 of the present invention were shown in Tables 1 to 7.

### Example 2 (Samples No. 66 to 69) and Comparative Examples 21 to 24

BaCO₃, TiO₂, Bi₂O₃, Na₂CO₃, and Sm₂O₃ were prepared as the raw materials and then weighed to have the composition as shown in Table 8 after the sintering process. Next, the resultant mixture was subjected to a wet mixing process with acetone in a ball mill followed by a drying process and a calcining process at 900° C. for 2 hours. In addition, as shown in Table 8, several kinds of raw material TiO₂ with different average particle sizes D50 were used.

The calcined body was subjected to a wet pulverizing process in pure water by using a ball mill. Here, the pulverization time in the ball mill was changed as shown in Table 8. In addition, the average particle size D50 of the pulverized powder was 0.35 to 3.2μm. Except that, the same production method was used and the same assessment was performed as that of Example 1. The results of Example 2 of the present invention were shown in Table 8.

In addition, in the present invention, a low resistivity at 25° C. referred to a resistivity of 10³ Ωcm or less. Similarly, a high withstand voltage referred to a withstand voltage of 300V/mm or more. Further, a high mechanical strength referred to a three-point bending strength of 100 MPa or more.

It could be known from Table 1 that the total content (b+c) of the range b of Bi and the range c of A was related to the Curie temperature and the resistivity at 25° C. A represented at least one element selected from the group consisting of Na and K. Based on Samples No. 1 to 8, it could be seen that when (b+c) was 0.017 or more and 0.25 or less, the Curie point shifted to a temperature higher than the Curie temperature of barium titanate of 120° C., and the resistivity at 25° C. was 10³ Ωcm or less. In Comparative Examples 1 and 3 where the range of (b+c) was less than 0.017, the resistivity at 25° C. was small and the Curie point did not shift to a temperature higher than 120° C. In addition, in Comparative Examples 2 and 4 where the range of (b+c) was higher than 0.25, the resistivity at 25° C. was found to exceed 10³ Ωcm to a great extent. Besides, when A was Na or K, the shifting amounts of the Curie point towards a higher temperature were different while the resistivity at 25° C. was almost the same.

TABLE 1

| | Grain size | | | | | | | | Three-point | | |
|---|---|---|---|---|---|---|---|---|---|---|---|
| | Maximum | Distribution | | | | | Resistivity | Withstand | bending | | A |
| | peak | frequency | b | c | e (Sm) | f | at 25° C. | voltage | strength | Tc | Na |
| Sample No. | [μm] | [%] | [mol] | [mol] | [mol] | [mol] | [Ωcm] | [V/mm] | [MPa] | [° C.] | or K |
| Comparative | 2.2 | 25 | 0.008 | 0.008 | 0.004 | 0 | 900 | 315 | 105 | 120 | Na |
| Example 1 | | | | | | | | | | | |
| 1 | 2.2 | 26 | 0.009 | 0.008 | 0.004 | 0 | 620 | 318 | 106 | 125 | |
| 2 | 2.5 | 28 | 0.050 | 0.050 | 0.004 | 0 | 510 | 320 | 109 | 160 | |
| 3 | 1.8 | 25 | 0.100 | 0.100 | 0.004 | 0 | 750 | 312 | 111 | 200 | |
| 4 | 1.5 | 24 | 0.125 | 0.125 | 0.004 | 0 | 950 | 316 | 120 | 210 | |
| Comparative | 1.5 | 22 | 0.130 | 0.130 | 0.004 | 0 | 1.0E+05 | — | 120 | — | |
| Example 2 | | | | | | | | | | | |
| Comparative | 2.0 | 28 | 0.008 | 0.008 | 0.004 | 0 | 900 | 330 | 110 | 120 | K |
| Example 3 | | | | | | | | | | | |
| 5 | 1.9 | 27 | 0.009 | 0.008 | 0.004 | 0 | 650 | 330 | 110 | 125 | |
| 6 | 2.9 | 24 | 0.050 | 0.050 | 0.004 | 0 | 560 | 308 | 108 | 175 | |
| 7 | 3.2 | 22 | 0.100 | 0.100 | 0.004 | 0 | 770 | 306 | 102 | 210 | |
| 8 | 2.5 | 22 | 0.125 | 0.125 | 0.004 | 0 | 950 | 307 | 104 | 225 | |
| Comparative | 1.9 | 21 | 0.130 | 0.130 | 0.004 | 0 | 1.0E+06 | — | 109 | — | |
| Example 4 | | | | | | | | | | | |

In addition, according to Table 2, it could be known that the resistivity at 25° C. was 10³ Ωcm or less in Samples No. 4 and 9 to 11 in which the range b of Bi and the range c of A satisfied 0.7≦b/c≦1.43. In Comparative Example 5 with the range being less than 0.07 or Comparative Example 6 with the range being higher than 1.43, the resistivity at 25° C. was found to exceed 10³ Ωcm to a great extent.

TABLE 2

| | Grain size | | | | | | | | Three-point | | |
|---|---|---|---|---|---|---|---|---|---|---|---|
| | Maximum | Distribution | | | | | Resistivity | Withstand | bending | | A |
| | peak | frequency | b + c | | e (Sm) | f | at 25° C. | voltage | strength | Tc | Na |
| Sample No. | [μm] | [%] | [mol] | b/c | [mol] | [mol] | [Ωcm] | [V/mm] | [MPa] | [° C.] | or K |
| Comparative | 3.0 | 20 | 0.25 | 0.65 | 0.004 | 0 | 1.0E+05 | — | 100 | — | Na |
| Example 5 | | | | | | | | | | | |
| 9 | 2.0 | 21 | 0.25 | 0.70 | 0.004 | 0 | 980 | 305 | 105 | 205 | |
| 4 | 1.5 | 24 | 0.25 | 1.00 | 0.004 | 0 | 950 | 316 | 120 | 210 | |
| 10 | 1.4 | 27 | 0.25 | 1.20 | 0.004 | 0 | 950 | 334 | 108 | 210 | |
| 11 | 1.2 | 29 | 0.25 | 1.43 | 0.004 | 0 | 965 | 340 | 119 | 210 | |
| Comparative | 1.1 | 29 | 0.25 | 1.45 | 0.004 | 0 | 1.0E+04 | — | 119 | — | |
| Example 6 | | | | | | | | | | | |

It could be known from Table 3 that the ratio (A/B) of (the total molar number of Ba, Bi, A, and RE) relative to (the total molar number of Ti and TM) had an influence on the resistivity at 25° C. In Sample No. 12 to 14 with the range of A/B being 1.001 or more and 1.06 or less, the resistivity at 25° C. slightly reduced. However, if the range of A/B exceeded 1.06, the resistivity at 25° C. trended to increase.

TABLE 3

| | Grain size | | | | | | | | | Three-point | | |
|---|---|---|---|---|---|---|---|---|---|---|---|---|
| | Maximum | Distribution | | | | | | Resistivity | Withstand | bending | | A |
| Sample | peak | frequency | b | c | e (Sm) | f | | at 25° C. | voltage | strength | Tc | Na |
| No. | [μm] | [%] | [mol] | [mol] | [mol] | [mol] | A/B | [Ωcm] | [V/mm] | [MPa] | [° C.] | or K |
| 2 | 2.5 | 28 | 0.050 | 0.050 | 0.004 | 0 | 1.0 | 510 | 320 | 109 | 160 | Na |
| 12 | 2.5 | 28 | 0.050 | 0.050 | 0.004 | 0 | 1.001 | 480 | 320 | 110 | 160 | |
| 13 | 2.3 | 25 | 0.050 | 0.050 | 0.004 | 0 | 1.02 | 490 | 322 | 113 | 160 | |
| 14 | 1.5 | 26 | 0.050 | 0.050 | 0.004 | 0 | 1.06 | 510 | 330 | 119 | 160 | |

It could be known from Table 4 that the range of element Ca was related to the resistivity at 25° C. In Samples No. 15 to 17 where the content of Ca was 0.049 mol or less, the resistivity at 25° C. slightly decreased. However, if the content exceeded 0.049 mol, the effect of decreasing the resistivity at 25° C. trended to improve.

TABLE 4

| | Grain size | | | | | | | | | Three-point | | |
|---|---|---|---|---|---|---|---|---|---|---|---|---|
| | Maximum | Distribution | | | | | | Resistivity | Withstand | bending | | A |
| Sample | peak | frequency | b | c | e (Sm) | f | Ca | at 25° C. | voltage | strength | Tc | Na |
| No. | [μm] | [%] | [mol] | [mol] | [mol] | [mol] | [mol] | [Ωcm] | [V/mm] | [Mpa] | [° C.] | or K |
| 2 | 2.5 | 28 | 0.050 | 0.050 | 0.004 | 0 | 0.0 | 510 | 320 | 109 | 160 | Na |
| 15 | 2.9 | 25 | 0.050 | 0.050 | 0.004 | 0 | 0.02 | 420 | 315 | 105 | 160 | |
| 16 | 2.7 | 24 | 0.050 | 0.050 | 0.004 | 0 | 0.035 | 480 | 308 | 104 | 160 | |
| 17 | 2.4 | 25 | 0.050 | 0.050 | 0.004 | 0 | 0.049 | 510 | 309 | 113 | 160 | |

It could be known from Samples No. 18 to 20 in Table 5 that an effect of decreasing the resistivity at 25° C. would be provided if the range of sub-component Si was 0.015 mol or less. However, if the range of Si was over 0.015 mol, the resistivity at 25° C. trended to increase.

TABLE 5

| | Grain size | | | | | | | | | Three-point | | |
|---|---|---|---|---|---|---|---|---|---|---|---|---|
| | Maximum | Distribution | | | | | | Resistivity | Withstand | bending | | A |
| Sample | peak | frequency | b | c | e (Sm) | f | Si | at 25° C. | voltage | strength | Tc | Na |
| No. | [μm] | [%] | [mol] | [mol] | [mol] | [mol] | [mol] | [Ωcm] | [V/mm] | [MPa] | [° C.] | or K |
| 2 | 2.5 | 28 | 0.050 | 0.050 | 0.004 | 0 | 0.0 | 510 | 320 | 109 | 160 | Na |
| 18 | 2.5 | 28 | 0.050 | 0.050 | 0.004 | 0 | 0.05 | 395 | 318 | 108 | 160 | |
| 19 | 2.6 | 25 | 0.050 | 0.050 | 0.004 | 0 | 0.01 | 490 | 325 | 111 | 160 | |
| 20 | 2.7 | 24 | 0.050 | 0.050 | 0.004 | 0 | 0.015 | 509 | 325 | 113 | 160 | |

It could be known from Samples No. 21 to 23 in Table 6 that as long as the range of Mn was 0.003 mol or less, the more the amount was, the higher the PTC jump would be. However, if the range exceeded 0.003 mol, the resistivity at 25° C. trended to increase.

TABLE 6

| | | | | | | | | | | | PTC | | |
|---|---|---|---|---|---|---|---|---|---|---|---|---|---|
| | Grain size | | | | | | | | | Three-point | jump in | | |
| | Maximum | Distribution | | | | | | Resistivity | Withstand | bending | 25 to | | A |
| Sample | peak | frequency | b | c | e (Sm) | f | Mn | at 25° C. | voltage | strength | 280° C. | Tc | Na |
| No. | [μm] | [%] | [mol] | [mol] | [mol] | [mol] | [mol] | [Ωcm] | [V/mm] | [MPa] | [digit] | [° C.] | or K |
| 2 | 2.5 | 28 | 0.050 | 0.050 | 0.004 | 0 | 0.0 | 510 | 320 | 109 | 3.6 | 160 | Na |
| 21 | 2.5 | 28 | 0.050 | 0.050 | 0.004 | 0 | 0.001 | 700 | 325 | 108 | 4.0 | 160 | |
| 22 | 2.3 | 26 | 0.050 | 0.050 | 0.004 | 0 | 0.002 | 850 | 330 | 105 | 4.3 | 160 | |
| 23 | 2.3 | 26 | 0.050 | 0.050 | 0.004 | 0 | 0.003 | 950 | 338 | 105 | 4.3 | 160 | |

It could be known from Samples No. 24 to 65 in Table 7 that if the total content (e+f) of RE and TM was 0.01 or less, the effect of decreasing the resistivity at 25° C. would be provided. Further, it was more preferred to be 0.001 mol or more and 0.006 mol or less. In addition, RE was more preferred to be La, Sm or Gd, and TM was more preferred to be Nb. Besides, in Comparative Examples 7 to 20 where (e+f) was higher than 0.01, the resistivity at 25° C. was found to exceed 10³ Ωcm. Further, it could be seen from Samples No. 60 to 65 that even if (e+f) was the same value, the case in which RE and RM was added with the same amount provided a small resistivity at 25° C.

TABLE 7

| | Grain size | | | | | | | | | | Three-point | | |
|---|---|---|---|---|---|---|---|---|---|---|---|---|---|
| | Maximum | Distribution | | | | | | | Resistivity | Withstand | bending | | A |
| | peak | frequency | b | c | | | e | f | at 25° C. | voltage | strength | Tc | Na |
| Sample No. | [μm] | [%] | [mol] | [mol] | RE | TM | [mol] | [mol] | [Ωcm] | [V/mm] | [MPa] | [° C.] | or K |
| Comparative | 2.7 | 24 | 0.05 | 0.05 | — | — | 0 | 0 | 1.0E+05 | — | 104 | — | Na |
| Example 7 | | | | | | | | | | | | | |
| 24 | 2.6 | 26 | 0.05 | 0.05 | Y | — | 0.001 | 0 | 750 | 315 | 104 | 160 | |
| 25 | 2.3 | 25 | 0.05 | 0.05 | | — | 0.006 | 0 | 600 | 310 | 109 | 160 | |
| 26 | 2.2 | 25 | 0.05 | 0.05 | | — | 0.01 | 0 | 910 | 319 | 110 | 160 | |
| Comparative | 2.6 | 26 | 0.05 | 0.05 | | — | 0.012 | 0 | 5.0E+03 | — | 105 | 160 | |
| Example 8 | | | | | | | | | | | | | |
| 27 | 2.6 | 26 | 0.05 | 0.05 | La | — | 0.001 | 0 | 720 | 315 | 105 | 160 | Na |
| 28 | 2.3 | 25 | 0.05 | 0.05 | | — | 0.006 | 0 | 560 | 309 | 107 | 160 | |
| 29 | 2.1 | 28 | 0.05 | 0.05 | | — | 0.01 | 0 | 850 | 317 | 109 | 160 | |
| Comparative | 2.0 | 27 | 0.05 | 0.05 | | — | 0.012 | 0 | 1.0E+04 | — | 109 | 160 | |
| Example 9 | | | | | | | | | | | | | |
| 30 | 2.6 | 24 | 0.05 | 0.05 | Ce | — | 0.001 | 0 | 760 | 311 | 104 | 160 | Na |
| 31 | 2.3 | 25 | 0.05 | 0.05 | | — | 0.006 | 0 | 610 | 311 | 106 | 160 | |
| 32 | 2.1 | 26 | 0.05 | 0.05 | | — | 0.01 | 0 | 930 | 316 | 108 | 160 | |
| Comparative | 2.1 | 26 | 0.05 | 0.05 | | — | 0.012 | 0 | 5.0E+03 | — | 108 | 160 | |
| Example 10 | | | | | | | | | | | | | |
| 33 | 2.6 | 23 | 0.05 | 0.05 | Pr | — | 0.001 | 0 | 780 | 312 | 104 | 160 | Na |
| 34 | 2.2 | 24 | 0.05 | 0.05 | | — | 0.006 | 0 | 650 | 317 | 107 | 160 | |
| 35 | 2.0 | 25 | 0.05 | 0.05 | | — | 0.01 | 0 | 950 | 322 | 109 | 160 | |
| Comparative | 2.0 | 25 | 0.05 | 0.05 | | — | 0.012 | 0 | 3.0E+03 | — | 109 | 160 | |
| Example 11 | | | | | | | | | | | | | |
| 36 | 2.6 | 26 | 0.05 | 0.05 | Nd | — | 0.001 | 0 | 750 | 310 | 104 | 160 | Na |
| 37 | 2.1 | 23 | 0.05 | 0.05 | | — | 0.006 | 0 | 610 | 307 | 108 | 160 | |
| 38 | 2.0 | 23 | 0.05 | 0.05 | | — | 0.01 | 0 | 890 | 313 | 109 | 160 | |
| Comparative | 2.0 | 23 | 0.05 | 0.05 | | — | 0.012 | 0 | 6.0E+03 | — | 109 | 160 | |
| Example 12 | | | | | | | | | | | | | |
| 39 | 2.6 | 26 | 0.05 | 0.05 | Sm | — | 0.001 | 0 | 720 | 318 | 106 | 160 | Na |
| 40 | 2.5 | 27 | 0.05 | 0.05 | | — | 0.006 | 0 | 570 | 315 | 107 | 160 | |
| 41 | 2.0 | 28 | 0.05 | 0.05 | | — | 0.01 | 0 | 830 | 326 | 109 | 160 | |
| Comparative | 2.0 | 28 | 0.05 | 0.05 | | — | 0.012 | 0 | 3.0E+03 | — | 109 | 160 | |
| Example 13 | | | | | | | | | | | | | |
| 42 | 2.6 | 25 | 0.05 | 0.05 | Gd | — | 0.001 | 0 | 710 | 315 | 105 | 160 | Na |
| 43 | 2.4 | 25 | 0.05 | 0.05 | | — | 0.006 | 0 | 580 | 313 | 109 | 160 | |
| 44 | 2.3 | 22 | 0.05 | 0.05 | | — | 0.01 | 0 | 860 | 322 | 110 | 160 | |
| Comparative | 2.3 | 22 | 0.05 | 0.05 | | — | 0.012 | 0 | 3.0E+03 | — | 110 | 160 | |
| Example 14 | | | | | | | | | | | | | |
| 45 | 2.6 | 26 | 0.05 | 0.05 | Dy | — | 0.001 | 0 | 800 | 313 | 103 | 160 | Na |
| 46 | 2.2 | 23 | 0.05 | 0.05 | | — | 0.006 | 0 | 660 | 308 | 106 | 160 | |
| 47 | 2.0 | 21 | 0.05 | 0.05 | | — | 0.01 | 0 | 950 | 317 | 108 | 160 | |
| Comparative | 2.0 | 21 | 0.05 | 0.05 | | — | 0.012 | 0 | 6.0E+03 | — | 108 | 160 | |
| Example 15 | | | | | | | | | | | | | |
| 48 | 2.6 | 26 | 0.05 | 0.05 | Er | — | 0.001 | 0 | 750 | 314 | 104 | 160 | Na |
| 49 | 2.2 | 24 | 0.05 | 0.05 | | — | 0.006 | 0 | 680 | 313 | 106 | 160 | |
| 50 | 2.0 | 23 | 0.05 | 0.05 | | — | 0.01 | 0 | 980 | 323 | 107 | 160 | |
| Comparative | 2.0 | 23 | 0.05 | 0.05 | | — | 0.012 | 0 | 3.0E+03 | — | 107 | 160 | |
| Example 16 | | | | | | | | | | | | | |
| 51 | 2.5 | 26 | 0.05 | 0.05 | — | V | 0 | 0.001 | 710 | 310 | 103 | 160 | Na |
| 52 | 2.0 | 23 | 0.05 | 0.05 | — | | 0 | 0.006 | 650 | 312 | 110 | 160 | |
| 53 | 1.9 | 23 | 0.05 | 0.05 | — | | 0 | 0.01 | 940 | 315 | 111 | 160 | |
| Comparative | 1.9 | 23 | 0.05 | 0.05 | — | | 0 | 0.012 | 1.0E+04 | — | 111 | 160 | |
| Example 17 | | | | | | | | | | | | | |
| 54 | 2.5 | 26 | 0.05 | 0.05 | — | Nb | 0 | 0.001 | 710 | 316 | 105 | 160 | Na |
| 55 | 2.3 | 25 | 0.05 | 0.05 | — | | 0 | 0.006 | 560 | 319 | 110 | 160 | |
| 56 | 2.1 | 28 | 0.05 | 0.05 | — | | 0 | 0.01 | 810 | 322 | 111 | 160 | |
| Comparative | 2.0 | 27 | 0.05 | 0.05 | — | | 0 | 0.012 | 3.0E+03 | — | 111 | 160 | |
| Example 18 | | | | | | | | | | | | | |
| 57 | 2.5 | 25 | 0.05 | 0.05 | — | Ta | 0 | 0.001 | 750 | 309 | 103 | 160 | Na |
| 58 | 2.0 | 23 | 0.05 | 0.05 | — | | 0 | 0.005 | 700 | 309 | 107 | 160 | |
| 59 | 1.9 | 21 | 0.05 | 0.05 | — | | 0 | 0.01 | 980 | 312 | 108 | 160 | |
| Comparative | 1.9 | 21 | 0.05 | 0.05 | — | | 0 | 0.012 | 7.0E+03 | — | 108 | 160 | |
| Example 19 | | | | | | | | | | | | | |
| 60 | 2.5 | 25 | 0.05 | 0.05 | Sm | Nb | 0.003 | 0.003 | 550 | 315 | 106 | 160 | Na |
| 61 | 2.5 | 26 | 0.05 | 0.05 | | | 0.001 | 0.005 | 560 | 315 | 106 | 160 | |
| 62 | 2.4 | 26 | 0.05 | 0.05 | | | 0.005 | 0.001 | 560 | 315 | 105 | 160 | |
| 63 | 2.5 | 21 | 0.05 | 0.05 | | | 0.005 | 0.005 | 800 | 317 | 104 | 160 | |
| 64 | 2.4 | 21 | 0.05 | 0.05 | | | 0.002 | 0.008 | 820 | 317 | 104 | 160 | |
| 65 | 2.4 | 21 | 0.05 | 0.05 | | | 0.008 | 0.002 | 820 | 317 | 106 | 160 | |
| Comparative | 1.9 | 18 | 0.05 | 0.05 | | | 0.006 | 0.006 | 1.0E+04 | — | 106 | 160 | |
| Example 20 | | | | | | | | | | | | | |

According to Table 8, the maximum peak of the grain size distribution was provided within the range of 1.1 μm or more and 4.0 μm or less, the distribution frequency of the peak was 20% or more, the withstand voltage was 300V/mm or more, and the three-point bending strength was 100 MPa or more by properly adjusting the particle diameter of the raw material TiO₂ and the pulverization time of the ball mill in Samples No. 66 to 69. On the other hand, in Comparative Examples 21 and 24, the maximum peaks of the grain size distribution were out of the optimal range and the three-point bending strengths were all less than 100 MPa through that the particle diameters of the raw material TiO₂ and the pulverization times in the ball mill were not properly adjusted. In addition, in Comparative Examples 22 and 23 where the particle diameters of the raw material TiO₂ and the pulverization times in the ball mill could not be properly adjusted, the maximum peaks of the grain size distribution fell within the range of 1.1 μm or more and 4.0 μm or less while the distribution frequencies of the peak were less than 20%, the withstand voltages were less than 300V/mm and the three-point bending strengths were less than 100 MPa. The reason was considered that when the grain size distribution broadened, coarse grains would partly exist, which caused to the decrease of the withstand voltage or the three-point bending strength. In addition, when the maximum peak of the grain size distribution fell within the range of 1.1 μm or more and 4.0 μm or less, the resistivity at 25° C. was almost the same.

TABLE 8

| | | | | | | | | | | | | D50 of | |
|---|---|---|---|---|---|---|---|---|---|---|---|---|---|
| | Grain size distribution | | | | | | | | Three-point | | A | the raw | Pulverization |
| | Maximum | Distribution | | | e | | Resistivity | Withstand | bending | | Na | material | time in |
| | peak | frequency | b | c | (Sm) | f | at 25° C. | voltage | strength | Tc | or | TiO₂ | ball mill |
| Sample No. | [μm] | [%] | [mol] | [mol] | [mol] | [mol] | [Ωcm] | [V/mm] | [MPa] | [° C.] | K | [μm] | (hour) |
| Comparative | 0.9 | 30 | 0.050 | 0.050 | 0.003 | 0 | 600 | 305 | 95 | 160 | Na | 0.5 μm | 20 |
| Example 21 | | | | | | | | | | | | | |
| Comparative | 1.1 | 18 | 0.050 | 0.050 | 0.003 | 0 | 550 | 290 | 98 | 160 | | 0.5 μm | 5 |
| Example 22 | | | | | | | | | | | | | |
| 66 | 1.1 | 20 | 0.050 | 0.050 | 0.003 | 0 | 530 | 304 | 103 | 160 | | 0.5 μm | 10 |
| 67 | 2.5 | 25 | 0.050 | 0.050 | 0.003 | 0 | 500 | 312 | 107 | 160 | | 0.7 μm | 15 |
| 68 | 2.5 | 30 | 0.050 | 0.050 | 0.003 | 0 | 510 | 348 | 110 | 160 | | 0.7 μm | 20 |
| 69 | 4.0 | 20 | 0.050 | 0.050 | 0.003 | 0 | 490 | 302 | 101 | 160 | | 3.0 μm | 10 |
| Comparative | 4.0 | 18 | 0.050 | 0.050 | 0.003 | 0 | 490 | 292 | 95 | 160 | | 3.0 μm | 5 |
| Example 23 | | | | | | | | | | | | | |
| Comparative | 4.2 | 22 | 0.050 | 0.050 | 0.003 | 0 | 470 | 280 | 95 | 160 | | 4.0 μm | 10 |
| Example 24 | | | | | | | | | | | | | |

### DESCRIPTION OF REFERENCE NUMERALS

1 PTC thermistor
2 ceramic body
3a, 3b electrode

What is claimed is:

1. A semiconductor ceramic composition which is a BaTiO₃ based semiconductor ceramic composition, wherein,
part of Ba is replaced by at least A, Bi and RE, and part of Ti is replaced by at least TM, wherein A represents at least one alkali metal element selected from the group consisting of Na and K, RE represents at least one element selected from rare earth elements including Y, and TM represents at least one element selected from the group consisting of V, Nb and Ta,
the relationships of 0.7≦{(the content of Bi)/(the content of A)}≦1.43, 0.017≦{(the content of Bi)+(the content of A)}≦0.25, and 0<{(the content of RE)+(the content of TM)}≦0.01 are satisfied when the total content of Ti and TM is set as 1 mol,
the semiconductor ceramic composition is composed of several crystal grains,
the grain sizes of the several crystal grains have a maximum peak in a grain size distribution in a range of 1.1 μm or more and 4.0 μm or less, and the distribution frequency of the peak is 20% or more.

2. A PTC thermistor comprising a ceramic body and a pair of electrodes formed on surfaces of the ceramic body, wherein,
the ceramic body is formed by using the semiconductor ceramic composition of claim 1.
